(19) United States
(12) Patent Application Publication
(10) Pub. No.: US 2016/0321955 A1
(43) Pub. Date: Nov. 3, 2016

(54) WEARABLE NAVIGATION ASSISTANCE FOR THE VISION-IMPAIRED

(71) Applicant: Research Foundation of the City University of New, New York, NY (US)

(72) Inventors: Zhigang Zhu, Princeton, NJ (US); Tony Ro, New York, NY (US); Lei Ai, Fort Lee, NJ (US); Wai Khoo, Jersey City, NJ (US); Edgardo Molina, Hollis, NY (US); Frank Palmer, Brooklyn, NY (US)

(21) Appl. No.: 15/210,359

(22) Filed: Jul. 14, 2016

Related U.S. Application Data
(63) Continuation-in-part of application No. 14/141,742, filed on Dec. 27, 2013, now abandoned.
(60) Provisional application No. 61/746,405, filed on Dec. 27, 2012.

(51) Int. Cl. G09B 21/00

(52) U.S. Cl. CPC G09B 21/003

(57) ABSTRACT

An assistive device includes a sensor that detects information using a first modality; an actuator that conveys information using a second, different modality; and a controller that automatically receives information from the sensor and operates the actuator to provide a corresponding actuation. A sensory assisting system for a user includes assistive devices and a support the user wears to hold the devices in proximity to body parts. The fields of view of the devices' sensors extend at least partly outward from the body parts. The controller reads the sensors and operates the corresponding actuators. The actuators are as close as possible to their corresponding sensors. A method of configuring a sensory assisting system includes successively activating actuators and receiving corresponding user feedback; determining perceptibility relationships for devices per the feedback; and repeatedly: activating the actuators per a virtual environment, a user avatar position, and the relationships; receiving a user navigation command; and moving the user avatar.

### CROSS-REFERENCE TO RELATED APPLICATIONS

This non-provisional application claims priority to, and is a continuation-in-part of, U.S. patent application Ser. No. 14/141,742 (filed Dec. 27, 2013) which claims the benefit of U.S. Provisional Patent Application Ser. No. 61/746,405 (filed Dec. 27, 2012) the entirety of which are incorporated herein by reference.

### STATEMENT OF FEDERALLY SPONSORED RESEARCH OR DEVELOPMENT

This invention was made with Government support under Contract No. 1137172 awarded by the National Science Foundation. The government has certain rights in the invention.

### TECHNICAL FIELD

The present application relates to obstacle-avoidance aids for individuals with reduced visibility, e.g., blind or low-vision individuals or individuals in low-visibility conditions such as darkness or fog.

### BACKGROUND

Blindness is a disability that affects millions of people throughout the world. According to the World Health Organization, there are 285 million people who are visually impaired worldwide. Performing normal navigational tasks in the modern world can be a burdensome task for them. The majority of assistive technologies that allow blind users to “feel” and “see” their environment require their active engagement/focus (both mentally and physically), or require the user to learn and adapt to the technology's “language”. If an assistive technology requires significant time and cognitive load to learn, it will be less acceptable to users. Many prior assistive technologies that have done well are those that are cost-effective and those for which the “language” of the device is intuitive. As an example, the language of the white cane is the direct force an obstacle in the environment produces against the colliding cane. On the other hand, sonar/IR range sensors or cameras have been devised that measure distance and convert that to different digital audio tones or vibrotactile feedback, but have not been widely successful. These devices require that a user learns unnatural tones, and the sensors and actuators are usually separately. For example, a camera is mounted on the head of a user, but a belt with a number of vibrotactile stimulator is used to give the user feedback on directions (Zelek, J. S. and Holbein, M., Wearable Tactile Navigation System, US2008/0120029A1, May 22, 2008). Or the sensors are on the cane of the user, and the vibrotactile stimulators are on some parts of the body (Duncan, D. M, A Walking Aid, WO 2012/159128 A2, 2012). Therefore the users have to cognitively map those to distances and or objects.

However, the functions of simple, cost-effective devices are very limited. Therefore, the user might need to have multiple devices in order to carry out the task of walking freely. In addition, many prior devices tend to overwhelm the sense(s) of the user (e.g., with constant voicing/sounding that may reduce the user's ability to hear oncoming traffic).

Many efforts have been made to develop a navigational aid for the blind. For example, the ARGUS II from Second Sight, a retinal prosthesis, consists of a camera mounted on some eyewear that communicates with an implanted receiver and a 6×10 electrode-studded array that is secured to the retina. Due to its low resolution signal (60 pixels), very little information is being conveyed from the camera to the retina and into the brain. The device is limited in the contrast, color, and depth information it can provide.

Unlike the invasive retina implant, BRAINPORT from Wicab is a tongue-based device that conveys the brightness contrast of a scene in front of the user through a 20×20 electrode array pressed against the tongue. A camera is mounted on some eyewear that captures a grayscale image and converts it into voltages across electrodes on the user's tongue. Some advantages are that it is hands-free and no surgery is needed. However, some disadvantages are that the device has to be in the mouth, which makes it awkward and difficult to speak, and the resolution of the device and ability to discriminate information on the tongue is very limited.

Depth perception is important for spatial navigation; many devices have been developed to utilize depth information. One scheme uses a camera to create a depth map, which is then translated into a series of sounds that convey the scene in front of the user (Gonzalez-Mora, J. L. et al. (2006), “Seeing the world by hearing: virtual acoustic space (VAS) a new space perception system for blind people”, in Information and Communication Technologies, pp. 837-842). While such a technique can convey substantial amounts of information, it has a high learning curve for appreciating variations in pitch and frequency, and it can easily overload a user's hearing. Another device uses sonar sensors that are mounted on the user's chest to convey spatial information via vibrators that are also on the chest (Cardin, S., Thalmann, D., and Vexo, F. (2007), “A wearable system for mobility improvement of visually impaired people”, The Visual Computer: Intl Journal of Computer Graphics, Vol. 23, No. 2, pp. 109-118). Also, the MICROSOFT KINECT depth sensor, which combines an infrared (IR) laser pattern projector and an infrared image sensor, has been used for depth perception. One depth-conveying device includes the MICROSOFT KINECT mounted on a helmet and depth information transmitted via a set of vibrators surrounding the head (Mann, S., et al. (2011), “Blind navigation with a wearable range camera and vibrotactile helmet”, in Proceedings of the 19th ACM international conference on Multimedia in Scottsdale, Ariz., ACM, pp. 1325-1328).

Haptic vibrational feedback has become quite a popular technique to help people perform tasks that need spatial acuity. There has been developed a rugged vibrotactile suit to aid soldiers performing combat-related tasks (Lindeman, R. W., Yanagida, Y., Noma, H., and Hosaka, K. (2006), “Wearable Vibrotactile Systems for Virtual Contact and Information Display,” Special Issue on Haptic Interfaces and Applications, Virtual Reality, Vol. 9, No. 2-3, pp. 203-213). Furthermore, vibrators have been paired with optical tracking systems (Lieberman, J. and Breazeal, C. (2007), “TIKL: Development of a wearable vibrotactile feedback suit for improved human motor learning,” IEEE Trans on Robotics, Vol. 23, No. 5, pp. 919-926) and inertial measurement units (Lee, B.-C., Chen, S., and Sienko, K. H. (2011), “A Wearable device for real-Time motion error detection and vibrotactile instructional cuing,” IEEE Trans on Neural Systems and Rehabilitation Engineering, Vol. 19, No. 4, pp. 374-381) to help people in physical therapy and mobility rehabilitation.

Obtaining ground truth of human performance in real world navigation tasks can be very challenging. There has been developed a virtual reality simulator that tracks the user's head orientation and position in a room. Instead of presenting the visual view of the scene to the user, an auditory representation of it is transduced (Tones-Gil, M. A., Gasanova-Gonzalez, O., Gonzalez-Mora, J. L. (2010), “Applications of virtual reality for visually impaired people”, Trans on Comp, Vol. 9, No. 2, pp. 184-193).

There is a continuing need for systems that assist users but permit the users to remain in control of their own navigation.

### BRIEF DESCRIPTION

According to an aspect, there is provided an assistive device, comprising:
a) a sensor adapted to detect information using a first modality;
b) an actuator adapted to convey information using a second, different modality; and
c) a controller adapted to automatically receive information from the sensor, determine a corresponding actuation, and operate the actuator to provide the determined actuation.

According to another aspect, there is provided a sensory assisting system for a user, comprising:
a) one or more assistive device(s), each comprising a sensor and an actuator operative in respective, different modalities, wherein each sensor has a respective field of view;
b) a support configured to be worn on the user's body and adapted to retain selected one(s) of the assistive device(s) in proximity to respective body part(s) so that the field of view of the sensor of each selected assistive device extends at least partly outward from the respective body part; and
c) a controller adapted to automatically receive data from the sensor(s) of at least some of the assistive device(s) and operate the corresponding actuator(s) in the same location of the sensor in response to the received data.

According to yet another aspect, there is provided a method of configuring a sensory assisting system using a virtual environment, the method comprising automatically performing the following steps using a processor:
successively activating respective actuator(s) of selected one(s) of a plurality of assistive devices at one or more output levels and receiving user feedback for each activation;
determining a perceptibility relationship for each of the selected assistive device(s) in response to the user feedback for that assistive device;
activating the respective actuators of the selected assistive device(s) according to contents of a virtual environment, a position of a user avatar in the virtual environment, and the respective determined perceptibility relationship(s);
receiving a user navigation command;
moving the user avatar within the virtual environment according to the user navigation command; and
repeating the activating, receiving-navigation-command, and moving steps.

Various aspects advantageously have a low cost and do not require a user to undergo extensive training in learning the basic language of the technology. Various aspects advantageously measure properties of the environment around the user and directly apply natural-feeling stimulation (e.g., simulating pressure or a nudge) at key locations where the sensors are worn. Various aspects use perceptibility relationships designed to not over-stimulate the user. Various aspects permit assisting workers in difficult environments where normal human vision systems do not work well.

Various aspects advantageously provide a whole-body wearable to ensure obstacle detection of a user's surroundings, multimodal sensor-actuator field system that can be useful for aiding in blind navigation. Various aspects advantageously customize the alternative perception for the blind, providing advantages described herein over computer vision or 3D imaging techniques.

Various aspects described herein are configured to learn the individual user's pattern of behavior; e.g., a device described herein can adapt itself based on the user's preference.

Various aspects use parts of the body that are normally covered up by clothing. This advantageously reduces potential interference to senses that could be used for other tasks, such as hearing.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a high-level diagram showing the components of an assistive device and a data-processing system;

FIG. 2 is a schematic of assistive devices (with the co-location of sensors and actuators) operatively arranged with respect to an individual's body;

FIG. 3 shows an exemplary calibration curve for a range sensor;

FIG. 4A is a top view, and FIG. 4B a left-side view, of a graphical representation of a user equipped with a schematically-illustrated sensory assisting system;

FIG. 5 is a flowchart and dataflow diagram illustrating exemplary methods for configuring a sensory assisting system;

FIGS. 6A-6F show experimental data of exemplary perceptibility relationships;

FIG. 7 is a graphical representation of an overhead perspective of a virtual environment for testing; and

FIG. 8 is a graphical representation of a user with a whole-body wearable system in a dead-end corridor.

The attached drawings are for purposes of illustration and are not necessarily to scale.

### DETAILED DESCRIPTION

In the description below and submitted herewith, some aspects will be described in terms that would ordinarily be implemented as software programs. Those skilled in the art will readily recognize that the equivalent of such software can also be constructed in hardware, firmware, or micro-code. Because data manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The skin of a user is used to provide feedback about the environment for navigation. One of the most intuitive forms of navigation used by anyone who is blind is his/her sense of touch. Devices and systems described herein transduce properties of the environment around a user in one or more modalities (e.g., spatial, motion, material or thermal), permitting the user to “feel” those properties with his skin without actually touching corresponding features of the environment. A non-visual wearable system according to various aspects includes sensor-stimulator pairs (referred to herein as “assistive devices”) that are worn on the whole body (and can be inexpensive), using vibrotactile, thermal and/or pressure, transducing for direct range, temperature and/or material sensing and object/obstacle detection. Unimodal, bimodal or multimodal information around the whole-body can be created so that the user can use their sense of touch on different body parts to directly feel the environment properties perpendicular to the body surface to plan his/her route, recognize objects (e.g. humans), detect motion, and avoid obstacles.

In accordance with various aspects, there is provided a navigation system for assisting persons with reduced visibility. These can include the visually-impaired, e.g., people who are blind, extremely near- or far-sighted, or otherwise in possession of reduced visual capability compared to the average sighted person. These can also include sighted persons whose vision is impaired or obscured by darkness, fog, smoke, haze, driving rain, blizzards, or other conditions. One or more assistive devices are attached to the person or his clothing, e.g., on armbands or in clothing pockets. Each assistive device includes a sensor and an actuator. The sensors can be, e.g., range or temperature sensors, or other types described in the attached (and likewise, throughout this paper, other aspects described later and in attached documents can be used). Sensors can sense in a particular direction; e.g., a sensor on an armband can sense normal to the surface of the arm at a point of attachment. The actuators can be vibrators, heat sources, or other types that cause a sensation that can be perceived by the sense of touch of the wearer. In various aspects, assistive devices can include auditory actuators (that produce audible sounds) in addition to tactile actuators.

The actuator and sensor in each assistive device are close enough together that the location of the sensation produced by that tactile actuator substantially corresponds to an obstacle or other feature of interest detected by that sensor, therefore the user does not have to learn the correspondences of the sensory information and the actuator's feedback. For example, an armband sensor can produce a vibration where the range sensor is worn, proportional in perceptibility (which can include amplitude, frequency, or pattern) to the proximity of an object in the field of view of that sensor. The armband sensor can be oriented to detect obstacles to the side of the wearer so that as the wearer approaches a wall on the side with the armband, the vibration on that side will increase in perceptibility.

The term “field of view” does not constrain the sensor to optical detection. For example, IR range sensors are discussed herein. The field of view of a IR range sensor is the volume of space in which the IR sensor can reliably detect the presence of an object.

Assistive devices can be incorporated in or attached to watches, belts, shirts, armbands, or other garments; or wrists, ankles, head, or other body parts. Assistive devices can also be attached to shoes, socks, pants, or other garments and oriented to look down, down and ahead, or down and behind. Such assistive devices can provide sensations useful in walking up or down a step or a flight of stairs. They can provide an alert (tactile or auditory) if a step is too far away or too close. Assistive devices, both sensor and actuator components, can be customized for different body parts and functions. Assistive devices can communicate with each other, wired or wireless, or can operate independently. On a given person, some assistive devices can communicate and some can operate independently.

Various aspects operatively couple a single sensor with a single stimulator on a particular body part. For example, an infrared (IR) range sensor paired with a vibrotactile actuator, the pair wearable on the wrist, can directly provide the user real-time range information in the direction the IR range sensor points in. This permits direct tactile sensation by the user of the range of the environment. Depending on the sensors that are used, the ranges can be within a meter (e.g. IR rangers) to several meters (ultrasound rangers) to tens meters (laser rangers). Various comparative approaches separate sensors (such as cameras, KINECT RGB-D sensors, etc) and stimulators (such as a vibrotactile array) and thus require a user to make cognitive connections between the two. Aspects described herein provide a significantly reduced cognitive load on the user.

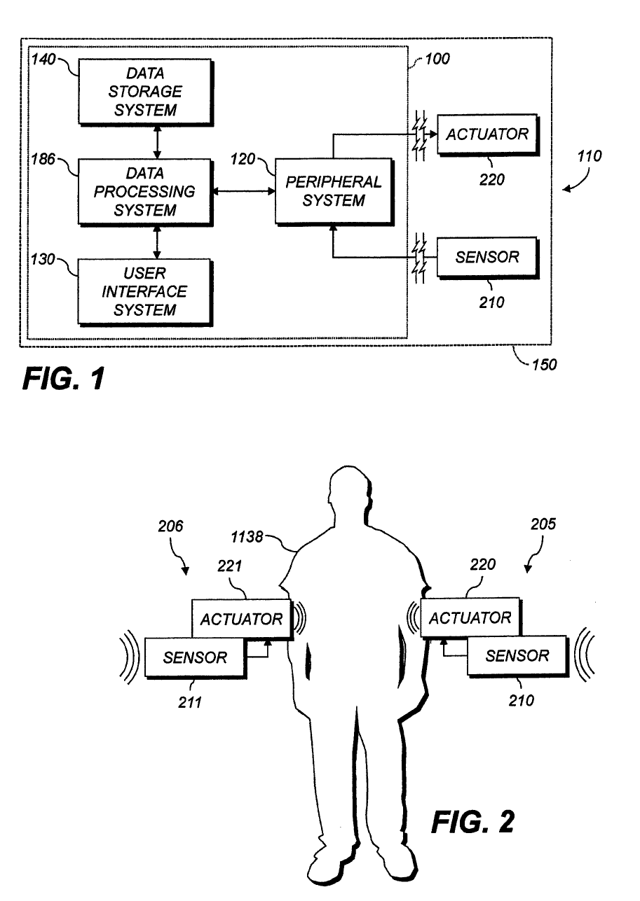

Various sensing and actuating units described herein can be worn at various points on the whole body. The omnidirectional nature of the skin of a user can be used to create a sensation of full immersive field of range, thermal and other forms of object properties to facilitate the navigation of the user. In various aspects, each assistive device will work on its own and rely on the human skin and brain to process the stimulation created by the wearable assistive system to make a decision. Various aspects also include a central processing unit (CPU) in a mobile computing device (e.g., data processing system 186, FIG. 1) that can be carried by the user for (a) system configuration and customization, such as intensity and range adjustments; (b) centralized data processing and sensing-unit control; and (c) data collection for further study. A wired or wireless communication unit can be included with each assistive device to transmit the data to the CPU.

In various aspects, the number, placement, and the parameters of the assistive devices on various parts of the body can be selected for each particular user. Modular designs can be used for the assistive devices, a virtual reality (VR) evaluation tool can be provided for system configuration and evaluation, and suitable methods can be used to measure and adjust the intensity of the stimulation.

Various aspects advantageously can use haptic feedback (e.g., vibration). Various devices are small and lightweight. No extensive user training is needed. An intuitive feedback mechanism is provided. No maneuvering of assistive devices is needed; they are simply worn. Testing can be performed in virtual reality (VR). A simple wearable design makes a vibrotactile prototype simple to use (substantially instant feedback at walking speed) and comfortable to wear. The assistive device can provide distance information via vibration. Various aspects deploy more sensors at strategic locations to improve coverage. Strategic placement of assistive devices can provide enough coverage for full 360 degree detection. Users only need to wear the sensors on body. Various aspects do not completely occupy one of the user's senses. A wearable design allows the users to use both of their hands for their daily tasks of interaction; learning curve is not steep. Strategic placement of sensors can provide enough coverage for full 360 degree detection. Any number of assistive devices can be employed to convey the needed 3D information to the user for navigation. Interface with the user can be, e.g., vibration, sound, or haptic. Objects can be detected, and information conveyed regarding objects, as far away from the user as the detection range of the sensor.

FIG. 1 is a high-level diagram showing the components of an assistive device 110. A controller 100 is configured to analyze image or other sensor data or perform other analyses described herein, e.g., as described below with reference to FIGS. 2-5. Controller 100 includes a data processing system 186, e.g., an ARDUINO microcontroller, that can be communicatively connected, e.g., via peripheral system 120, with a sensor 210 and an actuator 220. In an example, sensor 210 includes a distance sensor and actuator 220 includes a vibrator. The data processing system 186 can output a pulse-width modulated signal to drive the vibrators. An inductive component of the impedance of the vibrators can average the pulses into a corresponding equivalent voltage applied to the vibrator.

In various examples, assistive device 110 includes a housing 150. Each of the controller 100, the sensor 210, and the actuator 220 is arranged at least partly within the housing 150.

In other examples, sensor 210 and actuator 220 are arranged within the housing 150 and controller 100 is spaced apart from housing 150 and configured to communicate, e.g., wirelessly or via wires with sensor 210 and actuator 220. Specifically, in these examples the assistive device 110 includes a communications device (in peripheral system 120) configured to communicate data between the controller 100 and at least one of sensor 210 and actuator 220. The communications device can include a wireless interface. FIG. 2 shows assistive devices 205, 206 on body 1138 of an individual. Units 205, 206 include respective actuators 220, 221 activated in response to signals from respective sensors 210, 211. Each assistive device 205, 206 can include or be operatively connected to a controller 100, FIG. 1, that receives sensor signals and produces actuator commands.

In the example shown, assistive device 205 is arranged on the individual's left arm and assistive device 206 is arranged on the individual's right arm. Sensor 210 can detect obstacles or properties, e.g., in a field of view extending perpendicular to the surface of the body 1138. In this example, sensor 210 can detect objects on the user's left side, and actuator 220 can provide a sensation detectable by the user through the skin of the left arm. Sensor 211 can detect objects on the user's right side, and actuator 221 can provide a sensation detectable by the user through the skin of the right arm.

In various aspects, an assistive device includes sensor 210 adapted to detect information using a first modality and actuator 220 and adapted to convey information using a second, different modality. The controller 100 is adapted to automatically receive information from sensor 210, determine a corresponding actuation, and operate actuator 220 to provide the determined actuation. The first modality can include, e.g., range sensing using, e.g., a stereo camera or an infrared (IR), sonar, or laser rangefinder. The second modality can include vibrational actuation, e.g., using a cellular-telephone vibrator (a weight mounted off-center on the shaft of a motor). Similarly, with a pyroelectric-thermal assistive device, the actuator 220 can provide to the user's skin a sensation of temperature surrounding different objects, such as humans, vehicles, tables, or doors.

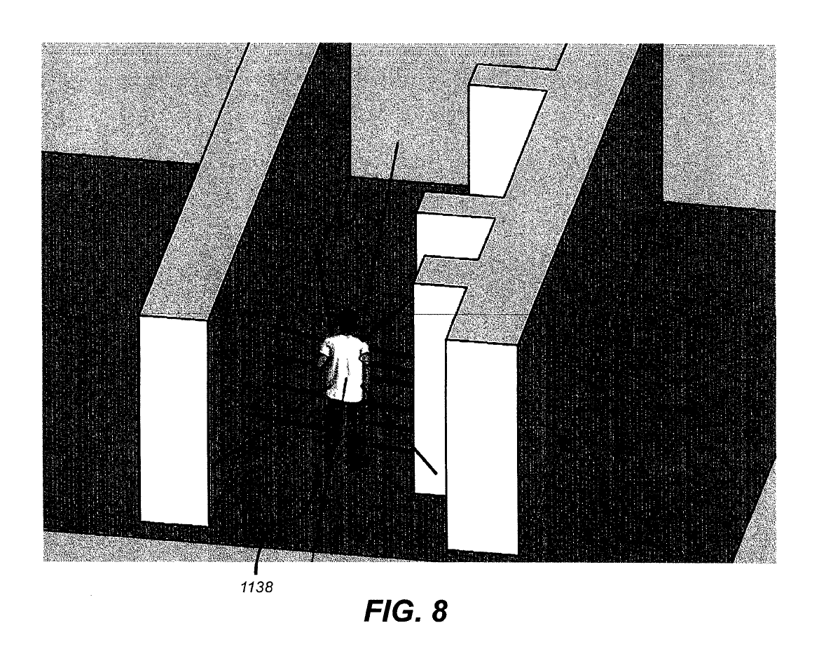

In an example, sensor 210 is configured to detect an object in proximity to the sensor. Controller 100 is configured to operate the actuator to provide the vibration having a perceptibility proportional to the detected proximity. The closer the object is, the stronger the vibration. An example is discussed below with reference to FIG. 8. Sensor 210 can include a SHARP GP2D12 Infrared Range Sensor, which detects the distance of any object that is directly in front of it and outputs a voltage corresponding to the distance between the object and the sensor. The outputs of sensor 210 can be linear or nonlinear with distance. A calibration table or curve can be produced and used to map between signals from sensor 210 and distance.

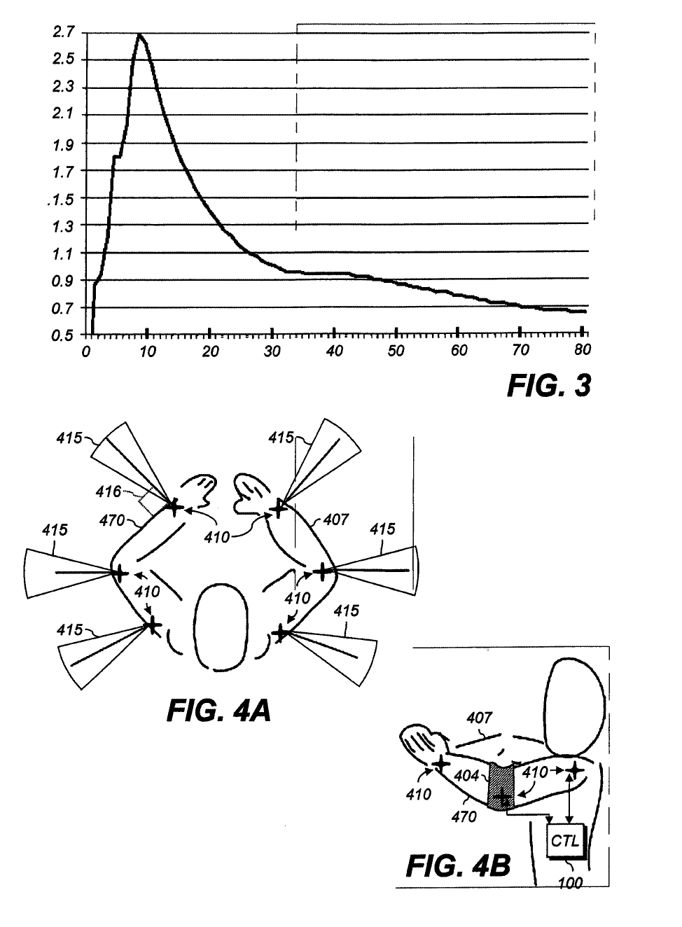

FIG. 3 shows an exemplary calibration curve for a GP2D12. The abscissa is distance between the sensor 210 and the object, in centimeters, and the ordinate is the output of the GP2D12, in volts. The SHARP GP2D12 operates on the principle of triangulation. The sensor has two lenses; one corresponds to an infrared light source, the other to a linear CCD array. During normal operation, a pulse of light is emitted by the infrared light source at an angle slightly less than 90 degrees from the side of the sensor containing the CCD array. This pulse travels in a straight line away from the emitter. If it fails to hit an object, then nothing is detected, but if it does hit an object, it bounces back and hits the linear CCD array. The lens in front of the CCD array refracts the returning pulse of light onto various parts of the CCD array depending on the angle at which it returned. The CCD array then outputs a voltage dependent on this angle, which through the principle of triangulation, is dependent on the distance of the object from the sensor. Thus, the sensor outputs the distance of an object from it in the form of varying voltage.

An array of inexpensive, low-powered range sensors connected to vibro-tactile actuators can be used to provide the wearer with information about the environment around him. For example, a group of sensors can be placed on the wearer's arms to provide the sensation of a “range field” on either side of him. This simulates the same kind of passive “spatial awareness” that sighted people have. Closer-proximity objects correspond to more vigorous vibration by the actuators, e.g., as discussed below with reference to FIG. 8. A different group of sensors can be provided, using the same type of inexpensive, low-powered range sensors and vibro-tactile actuators, to alert the wearer of distance information relevant to the placement of his feet.

In various aspects, one, some, or all sensors, vibrators, electronics, and wires can be detachable from the clothing associated with the device and can thus be able to be replaced. This permits testing many different combinations and configurations of sensors and vibrators to find a suitable approach. In various aspects, the second modality corresponds to the first modality. Examples of corresponding modalities are given in Table 1, below.

TABLE 1

| Sensor | Actuator | Comments |
|---|---|---|
| Temperature sensor | Heater | |
| (e.g., infrared | | |
| detector) | | |
| Proximity detector | Pressure applicator, | |
| | e.g., piston | |
| Infrared range sensor | Cell-phone vibrator | Can be used for close |
| | | range, e.g., ≦1 m |
| Ultrasonic range | Vibrator | Can be used for mid- |
| sensor | | range sensing, e.g., |
| | | ≦~3 m |
| Laser range sensor | Pressure actuator | Can be used for long- |
| | | range sensing, e.g., |
| | | ≦10 m |
| pyroelectric IR (PIR) | Thermal stimulator | Can be used for sensing |
| sensor (for | | humans without |
| temperature changes | | touching them, up to a |
| particularly due to | | range of 5 meters or |
| human movements) | | more. |
| Spectrometer | Pressure actuator | Can be used for sensing |
| | | material properties |

Using various modalities can provide various advantages. In various aspects, sensors and actuators permit the users, through their skins, to sense multiple properties of their surroundings, including range, thermal, and material properties of objects in the scene, to assist them to better navigate and recognize scenes. This can permit users to sense the environment for traversable path finding, obstacle avoidance, and scene understanding in navigation. Various aspects provide improvements over white canes and electronic travel aid (ETA) devices that require the user's hand attention.

Several prototypes have been developed based on this idea: hand sensor-display pairs for reaching tasks, arm and leg sensor sets for obstacle detection, and a foot sensor set for stair detection.

A range-vibrotactile field system was constructed using inexpensive IR ranger-vibrotactile pairs that are worn on the whole body. A “display” of range information is transduced via vibration on different parts of the body to allow the user 1138 to feel the range perpendicular to the surface of that part. This can provide the user a sensation of a whole body “range field” of vibration on part(s) of the body near obstacle(s) in which vibration intensifies as the wearer gets closer to the obstacle.

The constructed system includes two different types of sensors that provide different functions for their wearer. The first type, the arm sensor, is configured to vibrate at a rate that is roughly proportional to the distance of objects from the wearer's arms. This creates the impression of a “range field”. The second type, the foot sensor, is configured to vibrate when the distance between the downward facing sensor and the ground passes beyond a certain threshold, thus alerting the wearer to any possible precipices they may be stepping off. In an example, the support 404 is configured to retain a selected one of the sensor(s) 210 and a corresponding one of the actuator(s) 210 in proximity to a selected limb (left arm 470) of the user's body 1138. The selected sensor 210 is configured to detect an object in proximity to the selected sensor 210 and in the field of view (cone 415) of the selected sensor 210. The controller 100 is configured to operate the corresponding actuator 220 to provide a vibration having a perceptibility proportional to the detected proximity.

Each constructed arm sensor unit includes: a 6V voltage source, the Sharp GP2D12 Infrared Range Sensor, an OP Amp, and a small cellular phone vibrator. Both the range sensor and the OP Amp are powered by the 6V source. The output voltage from the range sensor is then connected to the “+” lead of the OP Amp, and the OP Amp is arranged as a signal follower. This allows for adequate isolation of the signal. The output from the OP Amp is then connected to the small vibrator to produce vibration proportional to the voltage output by the sensor.

Each constructed downward-facing foot sensor includes a comparator to provide thresholding. The assistive device includes a 6V source, a Sharp GP2D12 Infrared Range Sensor, a 5V voltage regulator, a comparator, an OP Amp, and a small vibrator. The range sensor, comparator, and OP Amp are all powered by the 6V source. Additionally, the 5V regulator is connected to the 6V source. Output from the range sensor is connected to the “−” terminal of the comparator, while the “+” terminal is connected to a reference voltage provided by the 5V regulator and a resistor network. The reference voltage is the threshold, corresponding to a selected distance detected by the sensor.

Sensor output below the threshold indicates that the range sensor has detected a distance greater than the threshold, and causes the OP Amp to output a 0V signal (as opposed to smaller distances, which correspond to an output of 5V). The 5V regulator is used to account for a gradual drop in the voltage output from the batteries, as well as irregularities in output. The resistor network is made to have as high a resistance as possible, to reduce power leakage. The output from the comparator is strengthened by the OP Amp in same manner as the arm sensors, and then connected to the vibrator. The other lead of the vibrator is connected to the 5V regulator. Thus the vibrator vibrates when the comparator outputs 0V, and stays still when it is outputting 5V.

In various aspects, the inputs from all of the sensors and are digitized and fed into a computer to log the data in different environments. This permits improving the efficiency of their arrangement. To log the data a microcontroller with Analog to Digital conversion can be used to relay data into the computer. A method of logging the data from the non-linear Sharp Sensor includes calibrating the sensor to several different distance intervals (see, e.g., FIG. 3), and using these intervals to approximate distance.

FIG. 4A is a top view, and FIG. 4B a left-side view, of a graphical representation of a user equipped with a schematically-illustrated sensory assisting system. The system includes one or more assistive device(s) 410. The assistive devices 410 are arranged, in this example, three on the user's left arm 470 and three on the user's right arm 407. Each assistive device 410 includes a sensor 210, FIG. 2, and an actuator 211, FIG. 2, operative in respective, different modalities. In various aspects, the actuator 211 of each of the assistive devices 410 is closer to the sensor 210 of that assistive device 410 than to the sensor 210 of any other assistive device 410. This advantageously provides a correlation between where the user experiences a sensation from the actuator 211 and the outside environment detected by the sensor 210.

Each sensor 210 has a respective field of view. The fields of view are represented graphically in FIG. 4A as cones 415. The centerlines of the cones are also shown. The centerlines can extend, e.g., perpendicular to the surface of the user's body at the sensor 210, as represented graphically by right-angle indicator 416.

FIG. 4B shows the user's left arm 470 and three assistive devices 410. The assistive device 410 at the user's elbow is retained by a support 404, in this example an elastic armband. The support 404 is configured to be worn on the user's body and is adapted to retain selected one(s) of the assistive device(s) 410 in proximity to respective body part(s) (e.g., left arm 470) so that the field of view (cone 415) of the sensor 210 of each selected assistive device 410 extends at least partly outward from the respective body part. In the example of FIGS. 4A and 4B, the support 404 is configured so that the field of view of at least one of the sensor(s) 210 extends at least partly laterally to a side of the user. The assistive device 410 can include the support 404 (e.g., the shown armband, or the housing 150) configured to retain the sensor 210 and the actuator 211 in a selected position with respect to each other. The support 404 can be configured to retain both the sensor 210 and the actuator 211 on a single selected limb of a user's body, e.g., the left arm 470 in the illustrated example, or the sensor on a shin and the actuator on a foot, as described herein. The support 404 can include a plurality of separate garments, e.g., a shirt or vest together with an armband.

An exemplary arrangement includes six assistive device(s) 410 on the arms, as shown, and one assistive device 410 on each leg, for a total of eight range sensors and small vibrators. The assistive devices 410 for each arm are placed on the upper arm, the elbow, and near the wrist, respectively. Each assistive device 410 includes an infrared range sensor 210 (e.g., as discussed above with reference to FIG. 3) and a vibrator as the actuator 211. The sensor 210 and the vibratory actuator 211 of each assistive device 410 are affixed to Velcro straps serving as the supports 404 for the assistive devices 410. One strap is used for each assistive device 410, in this example. Wires from the three assistive devices 410 on each arm run to a separate Velcro arm attachment, which includes the electronics (e.g., controller 100) and a power supply for the sensors on that arm. Thus each arm has its own electronics and power supply, and is completely independent of the sensor array on the other arm. The two leg sensors are facing downward, as discussed next. Each assistive device 410 can have its own controller 100, or a single controller 100 can control more than one assistive device 410 (sensor/actuator pair). Any number of controllers 100 and assistive devices 410 can be used.

In various examples, the support 404 is configured so that the field of view of at least one of the sensor(s) 210 extends at least partly below and at least partly ahead of a foot of the user. For example, each of the two leg sensors discussed above can be retained by such a support 404. In at least one example, the vibrator is arranged inside one of the wearer's shoes, and the sensor is attached, e.g., using Velcro, further up that leg. This allows the wearer to easily feel the vibrator on the most relevant part of their body (their foot), while allowing the sensor to have the distance it needs to operate effectively (e.g., >9 cm for the exemplary sensor response shown in FIG. 3). If wired interfaces are used, wires from the sensor and the vibrator can be arranged running up the wearer's legs into the left or right pants pockets of the wearer, which pockets can contain the electronics and power sources for the sensors attached to each leg of the wearer. The electronics and power for a sensor and a vibrator on the user's left leg can be located in the user's left pants pocket, and likewise for the right leg and the right pants pocket. Thus, the operation of each foot sensor can be independent of the operation of the other. Special-purpose pockets or other supports for the electronics can also be used. Straps can also be used to support sensors, actuators, or electronics.

In various embodiments, the support 404 can be configured to releasably retain a selected one or more of the assistive device(s) 410. For example, the support 404 can include one or more pocket(s) (not shown) into which selected assistive device(s) 410 can be placed, and fastener(s) to retain the selected assistive device(s) in the pocket(s).

FIG. 4B also shows controller 100 communicating with assistive device(s) 410. Controller 410 is adapted to automatically receive data from the sensor(s) 210 of at least some of the assistive device(s) 410 and to operate the corresponding actuator(s) 211 in response to the received data. Controller 100 can be as discussed herein with reference to FIG. 1. For example, the system can include one or more wire(s) or wireless communication unit(s) (not shown; e.g., peripheral system 120, FIG. 1) configured to connect the controller 100 to at least one of the sensor(s) 210 or at least one of the actuator(s) 211.

An experiment was performed. A visually impaired woman was equipped with a range sensor and a vibrotactile actuator, each fastened to her left arm using an armband. The subject indicated the experimental device was lightweight and easy to use because it provided direct information without much interpretation or learning. Using the experimental device, the user was able to navigate into a room without using her comparative retinal prosthesis.

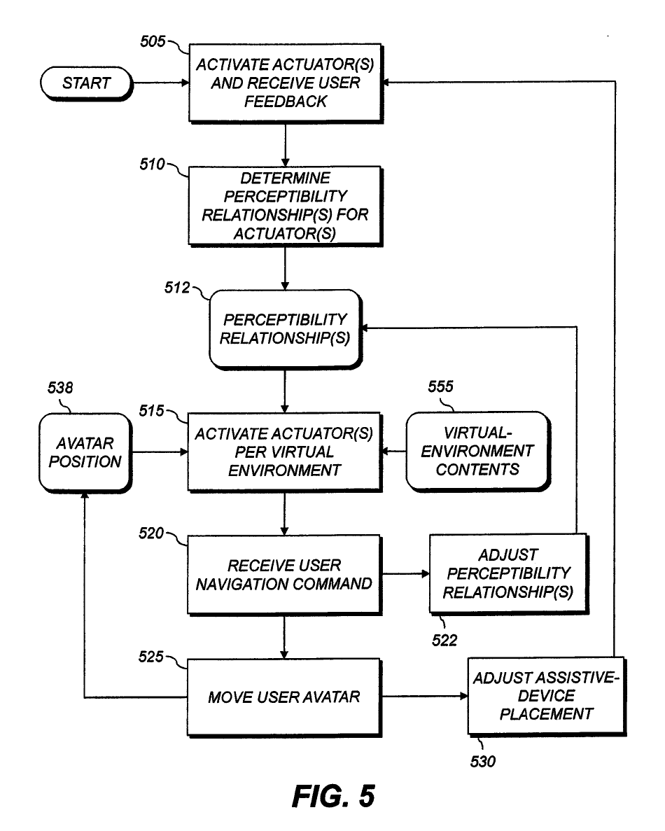

FIG. 5 is a flowchart illustrating exemplary methods for configuring a sensory assisting system. Also shown are data (rounded rectangles) produced by some of the steps and corresponding dataflow. The methods can include automatically performing steps described herein using a processor, e.g., data processing system 186, FIG. 1. For purposes of an exemplary embodiment, processing begins with step 505. For clarity of explanation, reference is herein made to various components shown in or described with reference to FIGS. 1-4B that can carry out or participate in the steps of the exemplary method. It should be noted, however, that other components can be used; that is, the exemplary method is not limited to being carried out by the identified components.

In step 505, respective actuator(s) of selected one(s) of a plurality of assistive devices are successively activated at one or more output levels and user feedback is received for each activation.

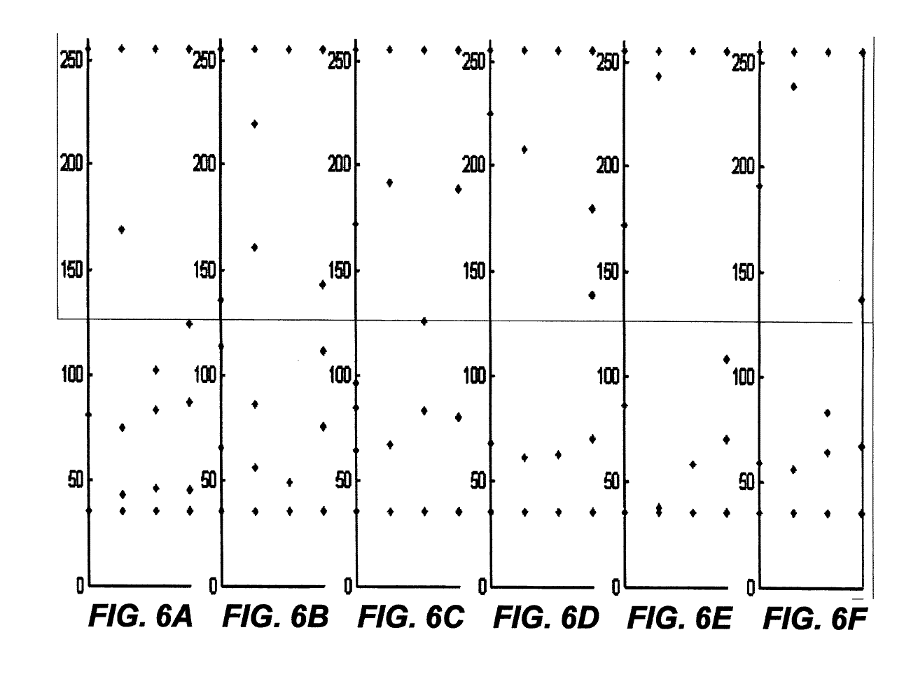

In step 510, a perceptibility relationship 512 for each of the selected assistive devices is determined in response to the user feedback for that assistive device. This can be done automatically using controller 100. Testing of stimuli and adjustment of the perceptibility relationship 512 can be done using various procedures known in the psychophysical and psychometric arts, e.g., PEST testing (“parameter estimation for sequential testing”) as per H. R. Lieberman and A. P. Pentland, “Microcomputer-based estimation of psychophysical thresholds: The Best PEST,” Behavior Research Methods & Instrumentation, vol. 14, no. 1, pp 21-25, 1982, incorporated herein by reference. Steps 505 and 510 permit determining whether the constant tactile stimulation would become “annoying” at a given level, and what are the sense thresholds for users to discriminate different levels of vibrations. This is discussed below with reference to FIGS. 6A-6F.

In step 515, the respective actuator(s) of the selected assistive device(s) (and optionally others of the plurality of assistive devices) are activated according to contents 555 of a virtual environment, a position 538 of a user avatar in the virtual environment, and the respective determined perceptibility relationship(s) 512. Not all of the actuator(s) of the selected assistive device(s) need to be caused to produce user-perceptible sensations simultaneously. For example, when the actuator(s) are activated and the user's avatar is in a clear area not near obstacles, the actuator(s) may not provide any sensations, indicating to the user that there are no obstacles nearby.

In step 520, a user navigation command is received, e.g., via the user interface system 130 or the peripheral system 120. Step 522 or step 525 can be next.

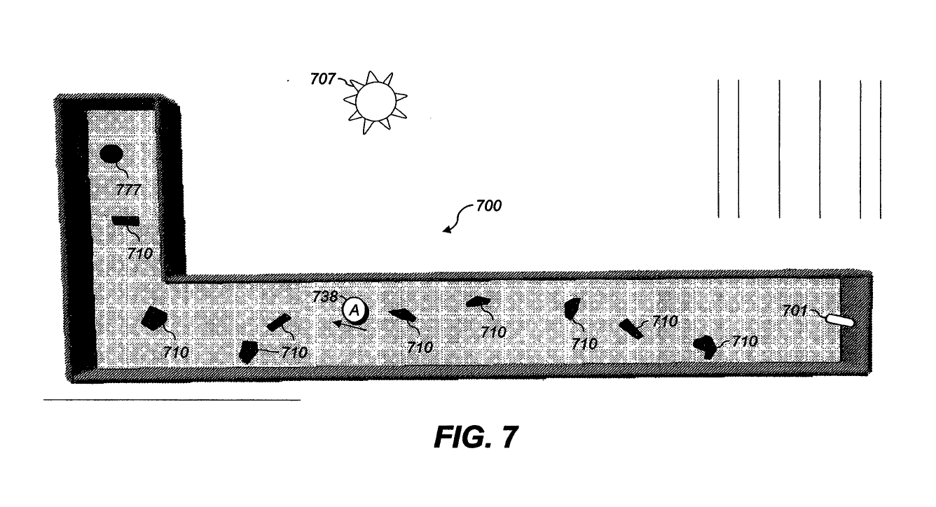

In step 525, the user avatar is moved within the virtual environment according to the user navigation command. Step 525 updates the avatar position 538 and is followed by step 515. In this way, activating step 515, receiving-navigation-command step 520, and moving step 525 are repeated, e.g., until the user is comfortable. This is discussed below with reference to FIG. 7, which shows an illustration of a virtual environment.

Still referring to FIG. 5, in various aspects, any of steps 515, 520, or 525 can be followed by step 530. In step 530, a placement of one of the assistive device(s) 410 is adjusted. Step 505 is next. In this way, successively-activating step 510, determining step 510, activating step 515, receiving step 520, and moving step 525 are repeated. Placements can be adjusted and user feedback received multiple times to iteratively determine a preferable configuration of the assistive devices 410. This permits analyzing the arrangement and design of these various types of sensors 210 or assistive devices 410 to advantageously provide improved navigational utility with a reduced number of sensors compared to prior schemes. Experiments can also be performed using various groups of subjects (sighted but blindfolded, low-vision, totally blind).

In various aspects, the location of assistive devices for a particular person is determined by activity in a virtual-reality (VR) environment. In various aspects, a particular person is trained to interpret the stimuli provided by the assistive devices by training in a virtual-reality (VR) environment. This can include seating a person in a chair; providing an input controller with which that person can navigate an avatar through a virtual-reality environment; equipping that person with one or more assistive device(s) 410 (e.g., placing the assistive devices 410 on the person or his clothing, which clothing can be close-fitting to increase the perceptibility of sensations from, e.g., vibrotactile actuators); providing stimuli to the person using the actuators in the assistive devices as the person navigates the VR environment (step 515), wherein the stimuli correspond to distances between the avatar and features of the VR environment (e.g., walls), to simulated features of the VR environment (e.g., heat from a stovetop or a fireplace: heat or vibration stimulus can correspond to the simulated infrared irradiance of the avatar from that heat source); and adjusting a perceptibility relationship of one of the assistive devices as the person navigates the VR environment (step 522).

The perceptibility relationship determines the perceptibility of stimulus provided by the actuator as a function of a property detected by the sensor. Perceptibility relationships for more than one of the assistive devices can be adjusted as the person navigates the VR environment (step 522). Initial perceptibility relationships, linear or nonlinear, can be assigned before the user navigates the VR environment (steps 505, 510). The perceptibility relationship can be adjusted by receiving feedback from the user (step 505) about the perceptibility of a given stimulus and changing the relationship (step 510) so the perceptibility for that stimulus more corresponds with user desires (e.g., reducing stimuli that are too strong or increasing stimuli that are too weak). The perceptibility relationship can be adjusted by monitoring the person's progress through the VR environment. For example, if the person is navigating an avatar down a hallway and is regularly approaching a wall and then veering away, the perceptibility of stimuli corresponding to the distance between the center of the hallway and the edge of the hallway can be increased. This can increase the ease with which the user can detect deviations from the centerline of the hallway, improving the accuracy with which the user can track his avatar down the center of the hallway.

Specifically, to various aspects step 522 includes adjusting the respective perceptibility relationship for at least one of the selected assistive device(s) in response to the received user navigation commands from step 520. Continuing the example above, the assistive device includes a distance sensor. The perceptibility relationship for the corresponding actuator is adjusted if the user regularly navigates the avatar too close to obstacles in the field of view of that distance sensor. Specifically, in various aspects, the at least one of the selected assistive device(s) 410 includes a sensor 210 having a field of view. Adjusting step 522 includes adjusting the perceptibility relationship for the at least one of the selected assistive device(s) 410 in response to user navigation commands indicating navigation in a direction corresponding to the field of view of the sensor 210 of the at least one of the selected assistive device(s) 410. In various aspects, when one point in the perceptibility relationship is altered (e.g., one stimulus altered in the hallway example) in step 522, other points are also altered. This can be done to maintain a desired smoothness of a mathematical curve or surface representing the perceptibility relationship, or to provide a natural feel for the user. Some human perceptions are logarithmic or power-law in nature (e.g., applications of Weber's law that just-noticeable difference is proportional to magnitude or Fechner's law that sensation increases logarithmically with increases in stimulus), so the perceptibility relationship can include an inverse-log or inverse-power component to provide perceptibly linear stimulus with linear sensor increase. In obstacle avoidance, the perceptibility relationship can also be altered to weight nearby objects more heavily than distant objects, so that stimulus increases ever faster as the object becomes ever closer (e.g., stimulus=1/distance, up to a selected maximum).

In various aspects, a PEST algorithm can be executed in the context of a virtual environment to determine sensitivity thresholds on a body part, or to permit the user to test a particular configuration (of sensitivity and placement) in a virtual environment, e.g., a maze, hallway, or living room. The placement of sensors, type of sensors (e.g. infrared and sonar), (virtual) properties of sensor(s) (e.g. range and field of view), and feedback intensity (sensitivity) can be adjusted using information from the actions of user 1138 in a virtual environment.

FIGS. 6A-6F show data from an experiment that was performed to test adjustment of perceptibility relationship 512 in step 510, both FIG. 5. A prototype shirt (support 404) with six vibrators was configured using an algorithm based on the PEST approach (Lieberman, 1982) for finding the thresholds for different parts of the body of a user. The shirt retained assistive devices 410 at the elbows, shoulders, and wrists of the wearer, e.g., as shown in FIGS. 4A and 4B. In other examples, sensors 210 are placed on other parts of the body, e.g., the legs, waist, chest, or back. The sensors were range sensors and the actuators were vibrotactile actuators. The PEST algorithm presents the user with sensations of more and more similar intensity of vibration, until the user indicates that they feel the same. The PEST algorithm operates in a manner similar to binary search.

In the test performed, users required about 45 minutes each to discern the range of detectable intensity differences for all six body locations tested. In some cases, especially those subjects with inconsistent responses, a tested algorithm was unable to detect a difference threshold and the program was halted before it had reached its conclusion. However, the difference thresholds that had been found up to that point were saved and recorded. In various aspects, testing can be performed in as little as a minute or two for each location, permitting performing full body vibration sensitivity evaluation in a reasonable amount of time, for example, within an hour for 100 locations.

FIGS. 6A-6F show experimental data for sensor units 410 located near six body parts: left wrist, left elbow, left shoulder, right shoulder, right elbow, and right wrist, respectively. Four human subjects were tested. On each graph, the ordinate is the voltage applied to the exemplary vibrator at a threshold, rescaled to the range from 0 to 255 (e.g., a vibrator driver DAC input code value). Each column of dots in each graph represents one human subject. The average interval distance and the average number of difference thresholds for each location along the arms are shown in Table 2. A second experiment was also performed, for which the data are shown in Table 3. Several observations were made regarding the experimental results and are discussed below.

TABLE 2

| | Left | Left | Left | Right | Right | Right |
|---|---|---|---|---|---|---|
| | Wrist | Elbow | Shoulder | Shoulder | Elbow | Wrist |
| Average | 62.86 | 58.67 | 62.86 | 73.33 | 80.0 | 73.33 |
| interval | | | | | | |
| length | | | | | | |
| Average | 4.5 | 4.75 | 4.5 | 4 | 3.75 | 4 |
| number of | | | | | | |
| thresholds | | | | | | |

TABLE 3

| | Left | Left | Left | Right | Right | Right |
|---|---|---|---|---|---|---|
| | Wrist | Elbow | Shoulder | Shoulder | Elbow | Wrist |
| Average | 77.6 | 77.6 | 82.5 | 94.3 | 94.3 | 94.23 |
| Interval | | | | | | |
| Length | | | | | | |
| Average | 3.8 | 3.8 | 3.7 | 3.3 | 3.3 | 3.3 |
| Number of | | | | | | |
| Thresholds | | | | | | |

Regarding similarity and differences among locations, it has been experimentally determined that, on average, the sensitivity of various locations of human arms is very similar. In the experiments performed, human arms were determined to be able to discern about 3-4 levels of vibration whose voltage is from 0 to 5 Volt. A tendency was observed for the left arms to be more sensitive to vibration than the right arms, although this difference was not statistically reliable.

Regarding similarity and differences among human subjects, it was experimentally determined that the number of difference thresholds of the test subjects varied from 3 to 6. However on average, the number was about 4. This demonstrates that, according to various aspects, users can be provided via their skin with three to four different vibration intensities. A “no vibration” condition can also be used to indicate, e.g., situations when the user is far enough from the nearest object that there is very little chance of collision. The controller 100 can divide the distance ranges into far/safe, medium, medium to close, close, and very close ranges and provide corresponding actuation profiles (e.g., no vibration, light, medium strong, and very strong vibration intensities, respectively), so the user can respond accordingly.

FIG. 7 is a graphical representation of an overhead perspective of a virtual environment 700. An experiment was performed using this virtual environment. Icon 707 represents the direction of the virtual light source used in producing this graphical representation. Virtual environments such as virtual environment 700 can be constructed using various tools, e.g., MICROSOFT ROBOTICS DEVELOPER STUDIO or UNITY3D. Such tools can be used to simulate multimodal sensors such as infrared (IR), sonar, and MICROSOFT KINECT. The computer used with UNITY3D in the experimental setup can operate over 60 vibrator outputs simultaneously, permitting using full-body wearable sensor suits.

In the experiment, eighteen subjects were outfitted with shirts having assistive devices 410 as described above with reference to FIGS. 4A, 4B, and 6A-6F. In terms of location, the sensors were configured as shown in FIGS. 4A-5B, as if the subject were walking with arms raised in front, elbows bent. The sensors are mounted on the wrists, elbows, and shoulders of the subjects and have field-of-view centerlines extending outward at 30, 90, 100 degree angles away from straight ahead for wrists, elbows, and shoulders, respectively. Test subjects that were not visually impaired were blindfolded. All test subjects were required to navigate an avatar 738 through virtual environment 700 using only the feedback from the assistive devices 410. Brain activity was monitored, and action recorded, while the user navigated avatar 738 toward goal 777.

The tested virtual environment 700 was an L-shaped hallway containing stationary non-player characters (NPCs) 710 the subject was directed to avoid while trying to reach a goal 777 at the end of the hallway. Feedback related to the location of goal 777 was provided by stereo headphones through which the subject could hear a repeated “chirp” sound emanating from the virtual position of goal 777. Each test subject manipulated a 3D mouse and a joystick to move avatar 738 through virtual environment 700, starting from initial position 701. Most test subjects reached goal 777, but taking an average of five minutes to do so, compared to an average of one minute of navigation for sighted subjects looking at a screen showing a visual representation of the view of virtual environment 700 seen by avatar 738.

Virtual environment 700 was simulated using UNITY3D. Distances between avatar 738 and other obstacles in the scene were determined using the UNITY3D raycast function. The raycast function is used to measure the distance from one point (e.g., a point on avatar 738 corresponding to the location on user 1138 of an assistive device 410) to game objects in a given direction. Controller 100 then activated the corresponding vibrator on the vibrotactile shirt with varying intensity according to the measured distance. Each subject was provided a steering device with which to turn the avatar between 90° counterclockwise and 90° clockwise. Each subject was also provided a joystick for moving the avatar 738 through virtual environment 700. The steering device used was a computer mouse cut open, with a knob attached to one of the rollers. Other user input controls can also be used to permit the subject to move the avatar 738.

18 subjects attempted to navigate virtual environment 700 and 10 were able to find the goal. Table 2 shows the time to completion and the number of bumps into walls or objects for subjects who experimented in virtual environment 700. The average time is 280.10 seconds and the average bumping is 17.3 for those who succeeded. And for those who failed, the average time is 288.65 seconds and the average bumping is 22.1. Details are given in Table 4.

TABLE 4

| Subject | Time (s) | Bumping | Result |
|---|---|---|---|
| S1 | 257.02 | 13 | Failed |
| S2 | 246.12 | 18 | Failed |
| S3 | 252.54 | 12 | Failed |
| S4 | 339.16 | 26 | Failed |
| S5 | 316.76 | 5 | Failed |
| S6 | 286.54 | 17 | Succeeded |
| S7 | 266.70 | 32 | Failed |
| S8 | 145.34 | 21 | Succeeded |
| S9 | 185.62 | 16 | Succeeded |
| S10 | 150.56 | 4 | Succeeded |
| S11 | 292.30 | 26 | Succeeded |
| S12 | 325.18 | 65 | Failed |
| S13 | 210.34 | 20 | Succeeded |
| S14 | 305.74 | 6 | Failed |
| S15 | 230.38 | 15 | Succeeded |
| S16 | 527.36 | 17 | Succeeded |
| S17 | 389.52 | 9 | Succeeded |
| S18 | 383.08 | 28 | Succeeded |

In other examples of experiments using virtual environments, a game-system controller such as an X-BOX controller can be used to control the avatar. The avatar can be configured to simulate a person sitting in a wheelchair, and the test subject can be seated in the wheelchair during the test. Multimodal sensing modalities can be used, e.g., a simulated low resolution image, a depth view, a simulated motion map, and infrared sensors. Multimodal sensory information can be transduced to various stimulators, such as motion information to a BRAINPORT tongue stimulation device, depth or low resolution views to a haptic device, or other modalities to other devices worn by the user (e.g., those discussed in the Background, above).

For example, simulated low resolution images can be fed into the BRAINPORT device for testing. The depth view can be obtained from a virtual MICROSOFT KINECT. The depth view can be used to derive the simulated motion map by computing the disparity value for each pixel, since the intrinsic and extrinsic parameters of the MICROSOFT KINECT are known. The depth view can also be used to test out obstacle detection algorithms that can provide feedback to a blind user either by speech or a vibrotactile belt. The motion map can be generated by shifting all of the pixel locations to the left and right by the corresponding disparity. The depth and virtual motion information can be translated into auditory or vibrotactile feedback to the user. There are many other types of stimulators beside vibrators and BRAINPORT-like stimulators. Since Braille is a traditional communication method for the visually impaired, it can be used to indicate range. Mimicking a bat's echolocation ability, distance information can be converted into stereophonics. Haptic feedback, which is similar to vibration, can also be used. The simulated sensory information from the virtual environment can be fed into real stimulators worn by the user or experimental subject.

FIG. 8 is a graphical representation of user 1138 in a dead-end corridor. The straight lines shown emanating from user 1138 show the distances between assistive devices 410 worn by user 1138 and the nearest object in the field of view of the sensor 210 of each assistive device 410. The thickness of each straight line represents the intensity of vibration provided by the corresponding actuator 211. As shown, closer objects correspond to stronger vibrations. This can advantageously warns user 1138 of the approach of objects as well as the distance to objects. The implementation of assistive devices 410 is discussed above with reference to FIGS. 2 and 3.

Referring back to FIG. 1, controller 100 includes a data processing system 186, a peripheral system 120, a user interface system 130, and a data storage system 140. The peripheral system 120, the user interface system 130 and the data storage system 140 are communicatively connected to the data processing system 186. Controller 100 includes one or more of systems 186, 120, 130, 140.

The data processing system 186 includes one or more data processing devices that implement the processes of the various aspects, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The data storage system 140 includes one or more processor-accessible memories configured to store information, including the information needed to execute the processes of the various aspects, including the example processes described herein. The data storage system 140 can be a distributed processor-accessible memory system including multiple processor-accessible memories communicatively connected to the data processing system 186 via a plurality of computers or devices. On the other hand, the data storage system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. The phrase “communicatively connected” is intended to include a connection between devices or programs within a single data processor, a connection between devices or programs located in different data processors, and a connection between devices not located in data processors. In this regard, although the data storage system 140 is shown separately from the data processing system 186, one skilled in the art will appreciate that the data storage system 140 can be stored completely or partially within the data processing system 186. Further in this regard, although the peripheral system 120 and the user interface system 130 are shown separately from the data processing system 186, one skilled in the art will appreciate that one or both of such systems can be stored completely or partially within the data processing system 186.

The peripheral system 120 can include one or more devices configured to provide digital content records to the data processing system 186. For example, the peripheral system 120 can include digital still cameras, digital video cameras, cellular phones, or other data processors. The data processing system 186, upon receipt of digital content records from a device in the peripheral system 120, can store such digital content records in the data storage system 140.

The user interface system 130 can include a mouse, a keyboard, another computer, or any device or combination of devices from which data is input to the data processing system 186. In this regard, although the peripheral system 120 is shown separately from the user interface system 130, the peripheral system 120 can be included as part of the user interface system 130.

The user interface system 130 also can include a display device, a processor-accessible memory, or any device or combination of devices to which data is output by the data processing system 186. In this regard, if the user interface system 130 includes a processor-accessible memory, such memory can be part of the data storage system 140 even though the user interface system 130 and the data storage system 140 are shown separately in FIG. 1.

As will be appreciated by one skilled in the art, aspects of the present invention may be embodied as a system, method, or computer program product. Accordingly, aspects of the present invention may take the form of an entirely hardware aspect, an entirely software aspect (including firmware, resident software, micro-code, etc.), or an aspect combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice method(s) according to various aspect(s).

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Non-transitory computer-readable media, such as floppy or hard disks or Flash drives or other nonvolatile-memory storage devices, can store instructions to cause a general- or special-purpose computer to carry out various methods described herein.

Program code and/or executable instructions embodied on a computer readable medium may be transmitted using any appropriate medium, including but not limited to wireless, wireline, optical fiber cable, RF, or any suitable combination of appropriate media.

Computer program code for carrying out operations for aspects of the present invention may be written in any combination of one or more programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The user's computer or the remote computer can be non-portable computers, such as conventional desktop personal computers (PCs), or can be portable computers such as tablets, cellular telephones, smartphones, or laptops.

Computer program instructions can be stored in a computer readable medium that can direct a computer, other programmable data processing apparatus, or other devices to function in a particular manner. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

The invention is inclusive of combinations of the aspects described herein. References to “a particular aspect” and the like refer to features that are present in at least one aspect of the invention. Separate references to “an aspect” or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

What is claimed is:

1. A sensory assisting system for a user, comprising:
a) a plurality of assistive devices, each comprising a sensor and an actuator operative in respective, different modalities, wherein each sensor and each actuator form a respective sensor-stimulator pair, each sensor has a respective field of view, wherein the actuator of each of the assistive devices is closer to the sensor of that assistive device than to the sensor of any other assistive device;
b) a corresponding number of supports each adapted to retain each sensor-stimulator pair in proximity to a respective body part, the field of view of the sensor of each sensor-stimulator pair extending at least partly outward from the respective body part, each respective body part being different; and
c) a controller adapted to automatically receive data from the sensors of each sensor-stimulator pair and operate the corresponding actuators in response to the received data.

2. The system according to claim 1, each support configured to releasably retain a selected one of the assistive devices.

3. The system according to claim 2, each support including a pocket into which the selected assistive device is placed, and a fastener to retain the selected assistive device in the pocket.

4. The system according to claim 1, further including one or more wire(s) or wireless communication unit(s) configured to connect the controller to at least one of the sensors or at least one of the actuators.

5. The system according to claim 1, wherein each support is configured so that the field of view of at least one of the sensors extends at least partly laterally to a side of the user.

6. The system according to claim 1, wherein each support is configured so that the field of view of at least one of the sensors extends at least partly below and at least partly ahead of a foot of the user.

7. The assistive device according to claim 1, wherein each support is configured to retain a selected one of the sensors and a corresponding one of the actuators in proximity to a selected limb of the user's body, the selected sensor is configured to detect an object in proximity to the selected sensor and in the field of view of the selected sensor, and the controller is configured to operate the corresponding actuator to provide a vibration having a perceptibility proportional to the detected proximity.

8. The system according to claim 1, wherein the plurality of assistive devices includes a first assistive device and a mechanically-interchangeable second assistive device, and the first and second assistive devices have respective, different sensor modalities or have respective, different actuator modalities.

9. The system according to claim 1, wherein the supports include a plurality of separate garments.

10. A method of configuring a sensory assisting system, the method comprising automatically performing the following steps using a processor:
successively activating respective actuator(s) of selected one(s) of a plurality of assistive devices at one or more output levels and receiving user feedback for each activation;
determining a perceptibility relationship for each of the selected assistive device(s) in response to the user feedback for that assistive device;
activating the respective actuators of the selected assistive device(s) according to contents of a virtual environment, a position of a user avatar in the virtual environment, and the respective determined perceptibility relationship(s);
receiving a user navigation command;
moving the user avatar within the virtual environment according to the user navigation command; and
repeating the activating, receiving-navigation-command, and moving steps.

11. The method according to claim 10, further including adjusting the perceptibility relationship for at least one of the selected assistive device(s) in response to the received user navigation commands.

12. The method according to claim 11, wherein the at least one of the selected assistive device(s) includes a sensor having a field of view and the adjusting step includes adjusting the perceptibility relationship for the at least one of the selected assistive device(s) in response to user navigation commands indicating navigation in a direction corresponding to the field of view of the sensor of the at least one of the selected assistive device(s).

13. The method according to claim 10, further including adjusting a placement of one of the assistive devices and then repeating the successively-activating, determining, activating, receiving, and moving steps.
